(19) United States
(12) Patent Application Publication
(10) Pub. No.: US 2002/0141695 A1
(43) Pub. Date: Oct. 3, 2002

(54) Method and apparatus for a dynamic gain equalizer for an erbium doped fiber amplifier

(75) Inventors: Uri Ghera, Tel Aviv (IL); Yoav Sintov, Petach Tivka (IL); Reuven Zaibel, Gan Yavne (IL)

Correspondence Address: DR MARK FRIEDMAN LTD, c/o Bill Polkinghorn - Discovery Dispatch, 9003 Florin Way, Upper Marlboro, MD, 20772, US

(73) Assignee: REDC OPTICAL NETWORKS LTD.

(21) Appl. No.: 09/777,843

(22) Filed: Feb. 7, 2001

(51) Int. Cl. G02B 6/26

(52) U.S. Cl. 385/27; 385/39; 359/141

(57) ABSTRACT

This invention is a dynamic gain equalizer for fiber optic communication systems with a spectral output that can be changed dynamically as needed by adjusting one or more variable power lasers providing optical pumping. The proposed dynamic gain equalizer can adjust power inequalities in WDM signals resulting from the gain properties of EDFA's. The dynamic gain equalizer uses erbium ions in a system that has not been pumped by a laser, or pumped only to a small extent, with the result that passing radiation can be absorbed by the erbium ion. For a given erbium doped fiber, with a given fiber length, the spectral absorption of the fiber is dependent on the signal power entering the erbium doped fiber for each of the signal wavelengths. In order to vary the absorption spectrum of the filter, the erbium doped fiber is pumped by a laser at a low power, to levels where the excited state population inversion either has not occurred or is insufficient to achieve total gain. By choosing the adequate type of Erbium fiber and by altering the pump level of the dynamic filter it is possible to reach a very large dynamic range of gain for a given EDFA This filter can be used as a stand alone device or in conjunction with a dichroic filter, or any other filter, and can be an important contributor for dynamic gain equalization in erbium doped fiber amplifiers.

### BACKGROUND OF THE INVENTION

1. Field of the Invention

The present invention relates generally to optical amplifiers used in fiber optics for telecommunications. More particularly, the invention relates to an optical fiber amplifier and a method and apparatus for equalizing amplified output at different wavelengths for multiple gain values.

2. Background Art

Communication channels can be provided in optical fiber communication systems by transmitting signals carried by laser beams of different wavelengths. Although optical fiber communication systems utilizing wavelength-distinct modulated channels may carry information over long distances, the signals transmitted through optical fibers are attenuated by the cumulative and combined effects of absorption and scattering. Information is usually transmitted through fiber optic transmission lines using laser wavelengths of 1525-1565 nm, where there is a low attenuation loss window. Although the signal attenuation rate in optical fibers is low within this wavelength range, signal reduction with increasing transmission distance requires periodic signal amplification for long distance transmission.

In wavelength division multiplexed fiber optic communication systems, where each data stream is transmitted in a different wavelength, an erbium doped fiber amplifier is the most commonly used device to amplify all wavelengths simultaneously [“Erbium Doped Fiber Amplifiers”, P. C. Becker, et. al., p. 335-346, Academic Press, 1999]. Due to the atomic properties of the erbium atoms in the silica fiber, the gain obtained by each of the wavelengths is different and thus signals that entered with the same power into the amplifier can exit with power difference that can reach a few decibels [“Optical Fiber Communication Systems”, L. Kozovsky, et. al., p. 578-584, Artech House, 1996]. This non-uniformity can have several serious consequences including a non-optimized power budget for the system. Furthermore, in a case of a chain of a few amplifiers, each amplifier can enhance the power non-uniformly and, in extreme cases, the wavelengths with smallest gain may be undetectable. Other serious consequences include cross-talk that can occur after traversing optical filters in components such as optical multiplexors or optical demultiplexors and a non-optimized use of the population inversion of the erbium doped fiber amplifier.

For the reasons mentioned above, a need for a gain equalization filter was identified by A. R. Charplevy (Charplevy et al., U.S. Pat. No. 5,225,922). Gain equalization is usually accomplished by means of passive filters with devices such as thin-film filters [“DWDM Technology”, S. V. Kartalopuulos, p. 75-77, SPIE Press, 2000], Bragg gratings [“DWDM Technology”, S. V. Kartalopuulos, p. 78, SPIE Press, 2000], long period gratings and tapered fibers [“Optical Networks”, R. Ramaswami, et al., ;p. 101-102, Academic Press, 1998]. In two stage amplifiers there are other ways to achieve gain equalization, including choosing different types of erbium fiber for the two stages (Sugaya et al., U.S. Pat. No. 6,055,092), different lengths of erbium fiber (Alexander, U.S. Pat. No. 5,696,615), or by inserting devices such as filters, isolators or even attenuators between the two stages (Taylor, et al., U.S. Pat. No. 6,061,171; Alexander, U.S. Pat. No. 5,696,615). Dynamic filters, using Mach Zehnder silica waveguide structure were reported however they tend to be lossy devices (Renalli and Fondeur, Proceedings of ECOC 2000, Vol 3, pp 21-22, Munich Germany September 2000) Acoustically tuned optical amplifiers, have also been suggested [“Fiber Based Acousto-optic Filters”, B. Y. Kim, et al., OFC 99, TuN 4, p. 199-201] (Olshansky, U.S. Pat. No. 5,276,543) although they were never implemented commercially.

In most commercial EDFA's, the gain equalization filter is suitable for a predetermined amplifier gain. When there is a need to change the gain, the power equalization of the different wavelengths will be different and no longer optimal. As the equality of the power levels is important, in many uses an attenuator is inserted in front of the amplifier to lower the signal power and accommodate the need for optimized gain for power equalization (Sugaya, U.S. Pat. No. 5,812,710). This technique wastes energy and deteriorate the noise figure of the amplifier . From the details mentioned above it is clear that there is need for a filter whose spectral shape can be changed dynamically to equalize gain.

### SUMMARY OF THE INVENTION

The present invention is a dynamic gain equalizer for an EDFA. Its major use is in conjunction with an EDFA that corrupted the power equalization between the various wavelengths. The dynamic gain equalizer unit will fix power inequality for a wide dynamic range of EDFA gains. The dynamic gain equalizer is based on an Erbium doped fiber pumped only to a small extent or totally unpumped, with the result that passing radiation is absorbed by the erbium ions instead of being amplified.

Generally, an erbium doped fiber can be used as a wavelength dependent absorber at the C-Band (1530 nm to 1565 nm) transmission window, if it has not been excited by optical pumping. The absorption depends on power of the signals, erbium fiber length and erbium ion concentration. For a given erbium doped fiber, with a given fiber length, the spectral absorption of the fiber is dependent only on the signal power entering the erbium doped fiber for each of the signal wavelengths. In order to vary the absorption spectrum of the filter, the erbium doped fiber is pumped by a laser at a low power, to levels where the excited state population inversion either has not occurred or is insufficient to achieve total gain. (Not pumping the doped fiber at all is considered herein to be a special case of this “low power pumping”.) In this way a dynamic gain equalization filter can be constructed.

This filter can be used as a stand alone device or in conjunction with a dichroic filter, or any other filter, and can be an important contributor for dynamic gain equalization in erbium doped fiber amplifiers.

Therefore, according to the present invention, there is provided a method of adjusting powers of signals that are carried substantially simultaneously on an optical fiber transmission line and that are amplified by a doped fiber amplifier that includes a first dopant at a certain concentration, including the steps of: (a) optically coupling at least one attenuating fiber to the transmission line, so that the signals traverse the at least one attenuating fiber; and (b) pumping the at least one attenuating fiber at a pump power insufficient to achieve total gain.

Furthermore, according to the present invention, there is provided an apparatus for adjusting powers of signals that are carried on an optical fiber transmission line, including: (a) an attenuating fiber, optically coupled to the transmission line so that the signals traverse the attenuating fiber; and (b) an attenuation control pump laser for pumping the attenuating fiber at a pump power insufficient to achieve total gain as the signals traverse the attenuating fiber.

### BRIEF DESCRIPTION OF THE DRAWINGS

FIG. 1: Diagram of the dynamic gain equalizer for optical fiber transmission lines.

FIG. 2: Detailed description of the dynamic gain equalizer for optical fiber transmission lines.

FIG. 3: The output spectrum of the light leaving the erbium doped fiber amplifier.

FIG. 4: The erbium doped fiber amplifier spectrum after passing through the dynamic gain equalizer with a laser pumping power of 1 mW.

FIG. 5: The erbium doped fiber amplifier spectrum after passing through the dynamic gain equalizer with a laser pumping power of 4 mW.

FIG. 6: Description of the dynamic gain equalization process.

FIG. 7: Diagram of a system with two dynamic gain equalizers in series.

FIG. 8: Diagram of a system with a dynamic gain equalizer between two sections of an erbium doped fiber amplifier.

FIG. 9: Diagram of a system in which the same pump laser is used to pump both an erbium doped fiber amplifier and a dynamic gain equalizer.

FIGS. 10 and 11: Comparisons of output spectra of an EDFA with a passive filter designed for 18dB gain (top) vs. a dynamic gain equalization filter of the present invention (bottom) for two different EDFA pump powers and gains.

### DETAILED DESCRIPTION OF THE INVENTION

This invention is a dynamic gain equalizer for fiber optic communication systems with a spectral output that can be changed dynamically as needed by adjusting one or more variable power lasers providing optical pumping. The equalizer is mostly appropriate for adjusting power inequality resulting from the passing of the signals through Erbium Doped Fiber Amplifiers. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

Information is transmitted through fiber optic transmission lines using laser wavelengths of 1530-1565 nm. Every few tens of miles, optical amplifiers are located, amplifying the signals in the C-band.

It is desirable for all of the signals in a wave division multiplexed transmission to have similar power levels. However, the erbium doped fiber amplifier does not uniformly amplify each of the wavelengths with the result that there are significant differences in gain at different wavelengths. The present invention provides a way of equalizing the gain across the various wavelengths being transmitted dynamically so that the response may change as conditions require.

The invention uses erbium doped fiber that has been pumped only to a small extent, with the result that the passing light wave can be absorbed by the erbium ions, raising them from the ground state to an excited state. When the erbium doped fiber has been pumped at very low power, the absorption spectra of this fiber has an inverted spectral shape in comparison to the shape of the output spectrum of the highly pumped erbium doped optical fiber. Whereas the highly pumped erbium doped fiber emits energy, the unpumped fiber absorbs energy. Thus, erbium doped fibers can be used as an efficient gain equalizer by absorbing energy from passing light. Moreover, the light from short wavelengths (blue band: 1530 nm to 1545 nm) is absorbed in the Erbium Doped Fiber and transferred to the longer wavelengths (red band: 1545 nm to 1565 nm), and thus further changes filter spectral characteristics.

In order to vary the absorption spectrum of the filter, the erbium doped fiber is pumped at a low power, to levels where the electronic state population inversion either has not occurred or is insufficient to achieve total gain. In this way a dynamic gain equalization filter can be constructed. In most of the embodiments it will be preferable to use an Erbium fiber with characteristics different from the fiber used in the original amplifier. This is due to the following limitation on the gain dynamic range, in which gain equalization can be obtained, by using the same Erbium fiber type in both the original amplifier and gain equalizer:

$$\frac{{G}_{max} - {G}_{min} + Δ}{{G}_{max} - {G}_{min} - Δ} = \frac{{σ}_{e ( λ1 )} + {σ}_{a ( λ1 )}}{{σ}_{e ( λ2 )} + {σ}_{a ( λ2 )}}$$

Where:

Gₘₐₓ, Gₘᵢₙ—High and low edge of the gain dynamic range, respectively.

Δ—Equalization tolerance.

λ2, λ1—High and Low edge of the signals spectral span, respectively.

σ_{e(λ)}σ_{a(λ)}—Effective emission and absorption cross sections of the Erbium fiber, respectively (including the overlap integrals influence).

This limitation on the gain dynamic range, in which gain equalization can be achieved within the tolerance Δ, depends on the Erbium fiber characteristics. The flatter the fiber's spectral response is, the wider the dynamic range will be. Alternatively, the flatter the fiber's spectral response is, the lower the tolerance will be.

By using two different Erbium fiber types for the original amplifier and the gain equalizer, for example, by having different concentrations of erbium in the amplifier fiber and in the gain equalizer fiber, or by having different concentrations of co-dopants such as aluminum, germanium, lanthanum, ytterbium or thulium in the amplifier fiber and in the gain equalizer fiber, this limitation can be removed by using different pump sets for the original amplifier and gain equalizer, at each working point in the gain dynamic range. This can be seen in the following relation:

$$\frac{{G}_{max} - {G}_{min} + Δ}{{G}_{max} - {G}_{min} - Δ} = \frac{( {σ}_{e1 ( λ1 )} + {σ}_{a1 ( λ1 )} ) \cdot ( \overline{{n}_{G max}^{*}} - \overline{{n}_{G min}^{*}} ) \cdot {L}_{1} + ( {σ}_{e2 ( λ1 )} + {σ}_{a2 ( λ1 )} ) \cdot ( \overline{{N}_{G max}^{*}} - \overline{{N}_{G min}^{*}} ) \cdot {L}_{2}}{( {σ}_{e1 ( λ2 )} + {σ}_{a1 ( λ2 )} ) \cdot ( \overline{{n}_{G max}^{*}} - \overline{{n}_{G min}^{*}} ) \cdot {L}_{1} + ( {σ}_{e2 ( λ2 )} + {σ}_{a2 ( λ2 )} ) \cdot ( \overline{{N}_{G max}^{*}} - \overline{{N}_{G min}^{*}} ) \cdot {L}_{2}}$$

Where:

$$\overline{{n}_{G }^{*}} , \overline{{N}_{G }^{*}}$$

Average Erbium upper state population density in the original amplifier and gain equalizer, respectively, needed for achieving the required gain (G).

σ_{e,a1(λ)},σ_{e,a2(λ)}—Effective emission and absorption cross sections of the Erbium fibers of the original amplifier and gain equalizer, respectively (including the overlap integrals influence).

L₁,L₂—Amplifier and gain equalizer fiber lengths, respectively.

By adjusting properly the pump powers of the original amplifier and the gain equalizer, the appropriate values of

$$( \overline{{n}_{G max}^{*}} - \overline{{n}_{G min}^{*}} ) and ( \overline{{N}_{G max}^{*}} - \overline{{N}_{G min}^{*}} )$$

for covering the gain dynamic range (Gₘᵢₙ—Gₘₐₓ) at the tolerance Δ, can be achieved.

The bigger the difference between the two Erbium fibers constituting the original amplifier and the gain equalizer is, the wider the dynamic range will be, for a given pump limits. However, it is essential that the spectral shape of the two fibers cross sections will be roughly similar, for getting a flattened spectral yield at each working point inside the dynamic range. Adding an optical filter, customized for a specific dynamic range, between the original amplifier and the gain equalizer, lowers the demands from the pump diodes, and compensates for irregularities in the fibers spectral characteristics inside the spectral range.

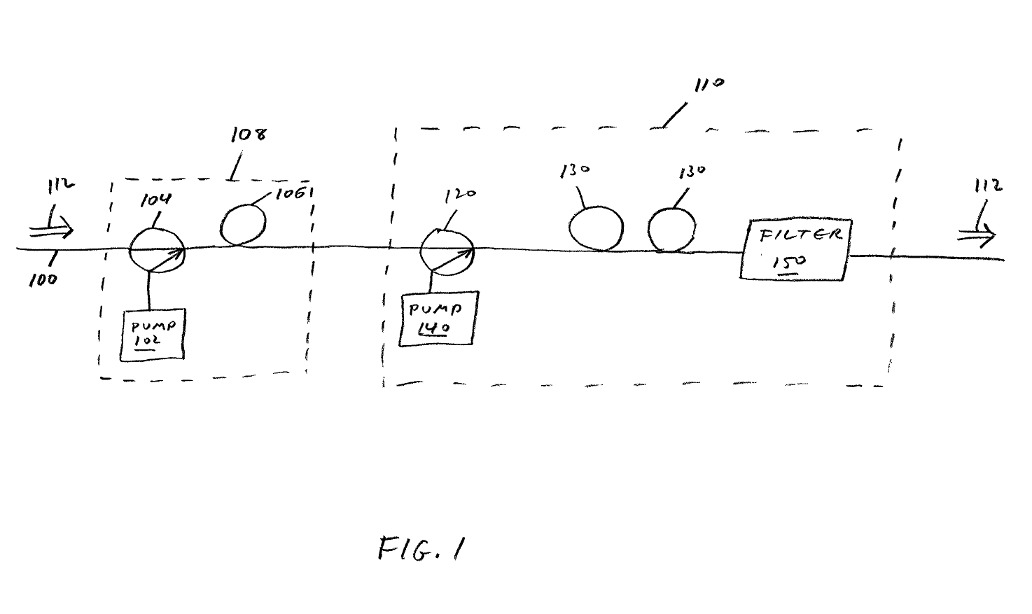

The apparatus of the present invention is shown in FIG. 1, where an optical transmission line 100 passes through an erbium doped fiber amplifier 108 and a dynamic filter 110. Erbium doped fiber amplifier 108 consists of: an amplification optical fiber 106 that is doped with erbium and that is optically coupled to transmission line 100 so that signals (represented by arrows 112) that are carried on transmission line 100 from left to right traverse amplification fiber 106; a pump laser 102; and a wavelength division multiplexing coupler 104 that couples the light from laser 102 into transmission line 100 so as to pump amplification fiber 106. Dynamic filter 110 consists of: one or more erbium doped attenuating optical fibers 130 that are optically coupled to transmission line 100 so that the signals that are carried on transmission line 100 traverse attenuating fibers 130; a variable low-power pump laser 140 to provide variable low power laser light to pump the erbium dopant of fibers 130 into an excited state; a wavelength division multiplexing coupler 120 that couples the light from laser 140 into transmission line 100 so as to pump attenuating fibers 130; and an optional passive filter 150. In the event that active components 130 and 140 of dynamic filter are unable to provide the desired filtering across various wavelengths, passive filter 150 can provide additional filtering to achieve equalization. As discussed earlier, optical fibers 106 and 130 might be doped with other elements besides erbium.

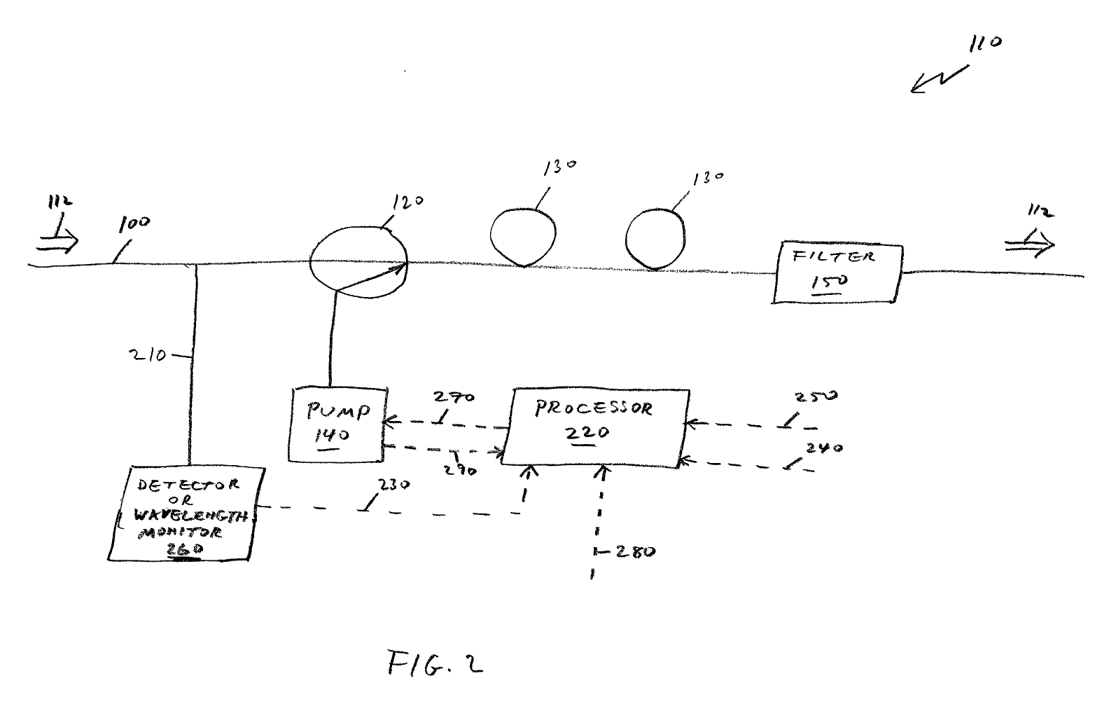

A more detailed depiction of dynamic filter 110 is shown in FIG. 2, where transmission line 100 passes by an input tap 210, and wavelength division multiplexing coupler 120. One or more erbium doped optical attenuating fibers 130 are spliced into transmission line 100 to allow coupling of the light for optical pumping and one or more optional passive filters 150 may also be provided. A variable low power laser 140 to pump the erbium of fibers 130, and a processing unit 220 are also shown in FIG. 2. One or more lasers 140 may be used to provide variable low power pumping. Input tap 210 samples incoming signal 112 in order to determine the power level of the signal entering filter 110. A detector or wavelength monitor 260 receives the signal through tap 210 and provides monitoring data of input signal 112 to processing unit 220. Processing unit 220 receives monitoring data 230 from input tap detector 260. Processing unit 220 also receives, from a database (not shown), data 250 concerning one or more optional passive filters 150, if present. Processing unit 220 also accesses a look-up table in the database with erbium fiber filter properties 240. Processing unit 220 also receives information 280 regarding the state of operation of erbium doped fiber amplifier 108. If laser 140 is uncooled, as illustrated, then processing unit 220 receives temperature measurements 290 of laser 140 directly from laser 140. The information gathered by processing unit 220 is used to determine the amount of pumping to be provided by variable low power laser or lasers 140. Processing unit 220 sends information to control variable low power laser pump or pumps 140 through a cable 270. Laser 140 must provide sufficient pumping to achieve equalization without pumping the erbium of fibers 130 into the region where amplification will occur. Passive filters 150, which may be, for example, dichroic filters, Bragg related filters or long period gratings, are designed for the expected spectrum of incoming signal 112 and the properties of dynamic filter 110. It is expected that dynamic filter 110 will be probably used in conjunction with erbium doped fiber amplifier 108 to provide equalization.

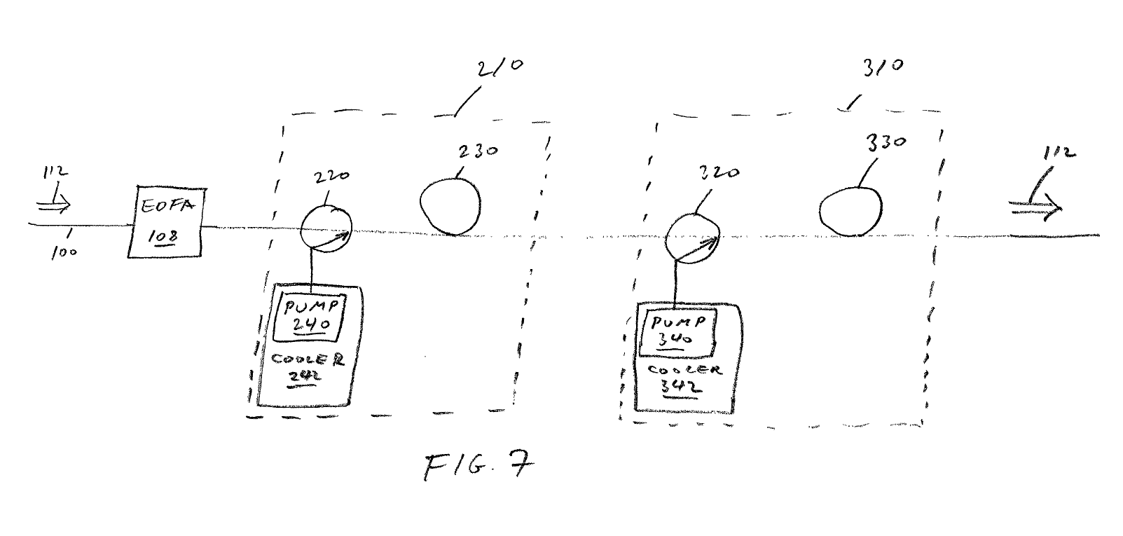

The process of equalizing the wavelengths is illustrated in FIG. 6. At step 600, processing unit 220 determines the amplification that is desired from user input. The incoming signal is monitored at step 610 through transmission line tap 210. At step 620, the processing unit looks up data to determine the erbium doped fiber 130 filtering properties and adjacent EDFA 108 properties (if such data exists). The presence of a dichroic or other passive filter 150 is considered at step 630. At step 640, processing unit 220 calculates the required the amount of erbium pumping, or excitation, to be provided by the variable strength laser or lasers 140. At step 650, the erbium doped fiber or fibers 130 are pumped to the desired level. The degree of optical pumping desired is determined by consideration of a number of factors, including: (1) the input and output power of the associated erbium doped fiber amplifier 108, (2) the input power to the device, (3) the data regarding properties of passive filter 150, if any, (4) the data in a look-up table providing erbium doped optical fiber 130 filter properties and (5) information regarding the specific wavelengths transmitted by the fiber and data regarding the parameters of adjacent EDFA 108.

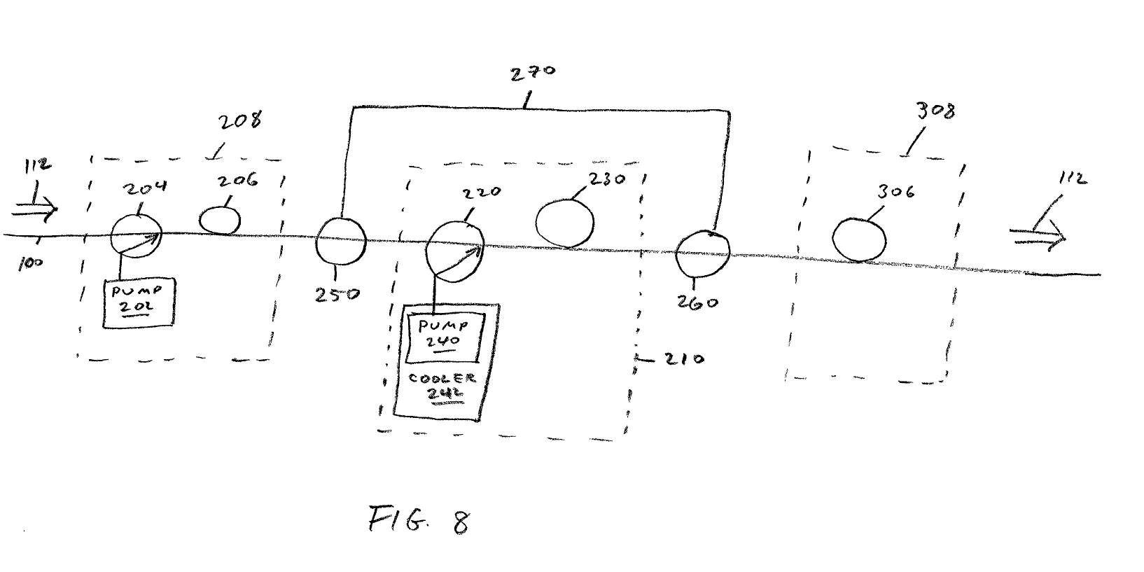

Generally, an erbium doped optical fiber can be used as a wavelength dependent absorber at selected wavelengths if it has not been excited by optical pumping. The signal absorption depends on signal power, co-existence with other signals of other wavelengths, erbium optical fiber length and erbium ion concentration [“Erbium Doped Fiber Amplifiers”, P. C. Becker, et. al., p. 153-178, Academic Press, 1999]. For a given erbium doped optical fiber, with a given fiber length, the spectral absorption of the fiber is dependent only on the signal power entering the erbium doped fiber for each of the signal wavelengths. In order to vary the absorption spectrum of the filter, the erbium doped fiber is pumped at a low power, to levels where the excited state population inversion either has not occurred or is insufficient to achieve total gain. The extent of pumping determines the amount of filtering. In this way a dynamic gain equalization filter can be constructed. Several individually pumped erbium doped fibers can be disposed in sequence in order to tailor the output spectrum to achieve specific results. Usually, each erbium doped fiber has a different respective dopant concentration. The erbium doped fibers all can be pumped by the same pump laser, as in dynamic filter 110, or each erbium doped fiber can be given its own pump laser, as in FIG. 7, which shows transmission line 100 equipped with EDFA 108 and two dynamic filters 210 and 310. Dynamic filter 210 includes a variable low-power pump laser 240, a wavelength division multiplexing coupler 220 and a single erbium doped attenuating optical fiber 230. Dynamic filter 310 includes a variable low-power pump laser 340, a wavelength division multiplexing coupler 320 and a single erbium doped attenuating optical fiber 330. Pump lasers 240 and 340 are illustrated as being cooled, for the purpose of temperature stabilization, by respective cooling units 242 and 342. Alternatively, pump lasers 240 and 340 may be uncooled.

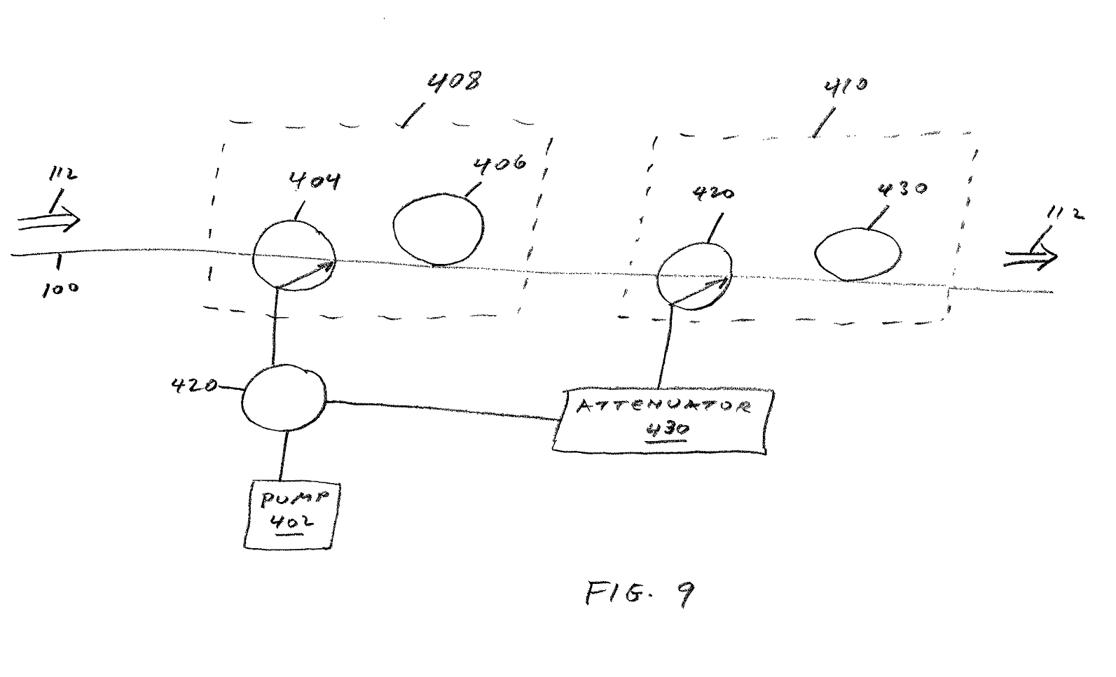

When used in conjunction with an erbium doped fiber amplifier, the dynamic gain equalizer of the present invention can be used as a midway Gain Equalization Filter (GEF) or as a gain equalization filter at the input or output of the erbium doped optical fiber amplifier. In a midway gain equalization filter, the filter is situated between two segments of erbium fiber that are a part of an erbium doped fiber amplifier. For gain equalization filter at the output or input end of an erbium doped fiber amplifier, the dynamic gain filter should be located between two optical isolators, such as the erbium doped fiber amplifier entrance or exit isolator and an additional isolator. The optical isolators allow the signal to travel in one direction only. This is illustrated in FIG. 8, which shows transmission line 100 with dynamic filter 210 between two sections 208 and 308 of an erbium doped fiber amplifier. Section 208 includes a pump laser 202, a wavelength division multiplexing coupler 204 and an erbium doped amplification fiber 206. Section 308 includes an erbium doped amplification fiber 306 but lacks a pump laser of its own. Instead, both erbium doped amplification fibers 206 and 306 are pumped by pump laser 202. To prevent the pumping of erbium doped attenuating fiber 230 by pump laser 202, a wavelength division demultiplexing coupler 250 and a wavelength division multiplexing coupler 260 are used to divert the pump light from pump laser 202 around dynamic filter 210 via bypass fiber 270.

FIGS. 1, 2, 7 and 8 illustrate systems in which the erbium doped fibers are downstream from their respective pump lasers, meaning that the light from the pump lasers is directed towards the erbium doped fibers in the same direction as the propagation of the signals represented by arrows 112. Reversing the directions of arrows 112 to represent signals that are carried on transmission line 110 from right to left turns FIGS. 1, 2, 7 and 8 into illustrations of systems in which the erbium doped fibers are upstream from their respective pump lasers, meaning that the light from the pump lasers is directed towards the erbium doped fibers in a direction opposite to the direction of signal propagation.

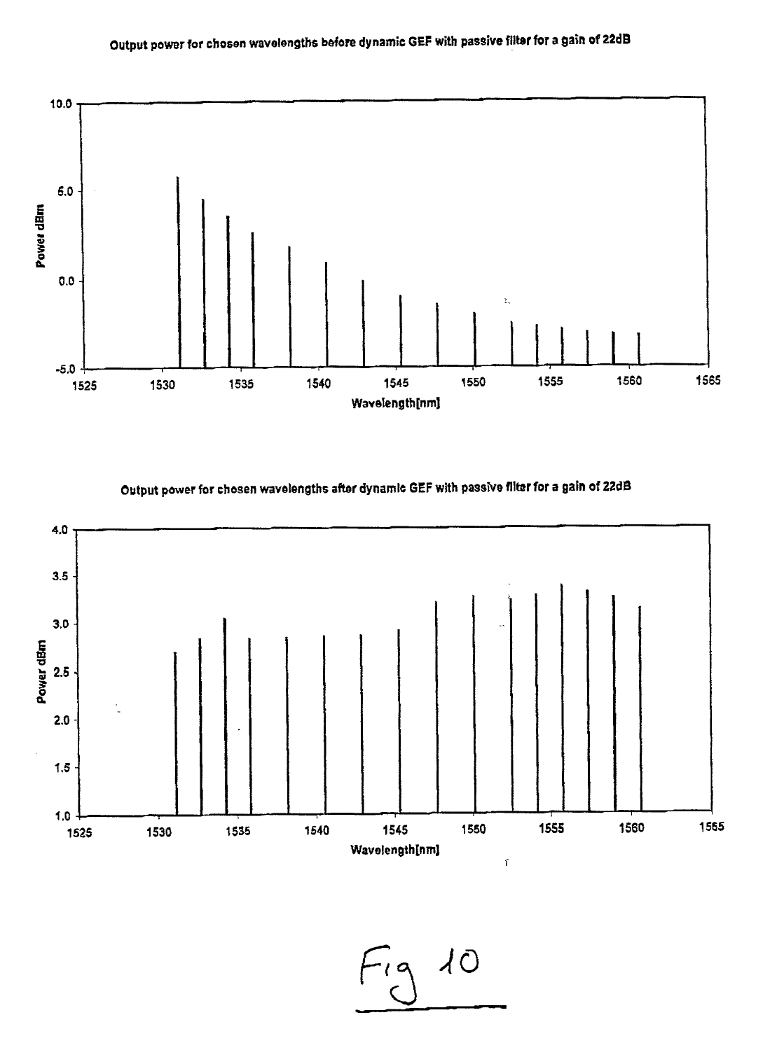

FIG. 9 illustrates a system in which a common pump laser 402 is used to pump both an erbium doped amplification fiber 406 of an erbium doped fiber amplifier 408 and an erbium doped attenuating fiber 430 of a dynamic filter 430. Light from pump laser 402 is split by a coupler 420 to follow two different optical paths. One optical path leads to a wavelength division multiplexing coupler 404 that couples the light from that optical path into transmission line 100 downstream from amplification fiber 406. The other optical path leads to a variable attenuator 430 that reduces the power of the light in that optical path to the desired level, and thence to a wavelength division multiplexing coupler 430 that couples the attenuated light into transmission line 100 downstream from attenuating fiber 430.

As an example, in an three meter long erbium doped optical fiber containing a 500 ppm concentration of erbium, consider the initial transmission of the following wavelength signals, where power of the signal at each wavelength, λ, is 0 dBm (or 1 mW):

λ/input=[1532/0 1536/0 1540/0 1544/0 1548/0 1552/0 1556/0 1560/0]

After passing through the dynamic gain equalizer in an unpumped configuration, the power per wavelength is:

[−2.8 −1.7 −1.1 −0.6 −0.2 0.2 0.5 0.7]

where the results are in dBm. If the optical fiber is pumped by a 1 mW laser, the results change to:

[−2.3 −1.3 −0.7 −0.3 0.2 0.5 0.8 1.0]

If the fiber is pumped by a 2 mW laser, the results change to:

[−1.8 −0.9 −0.4 −0.1 0.4 0.8 1.0 1.2]

In this example, because of the slight difference between the absorption and gain spectrum, part of the energy of the photons in the highly absorptive wavelengths is transferred to the erbium ions and generates a small gain at longer wavelengths. As longer wavelengths from the C-band (1530-1565 nm) in an erbium doped fiber amplifier usually suffer from lower amplification, this process can contribute to gain equalization. The filter can be used as a stand alone device or in conjunction with a dichroic filter or any other filter, and can be an important contributor for dynamic gain equalization in erbium doped optical fiber amplifiers.

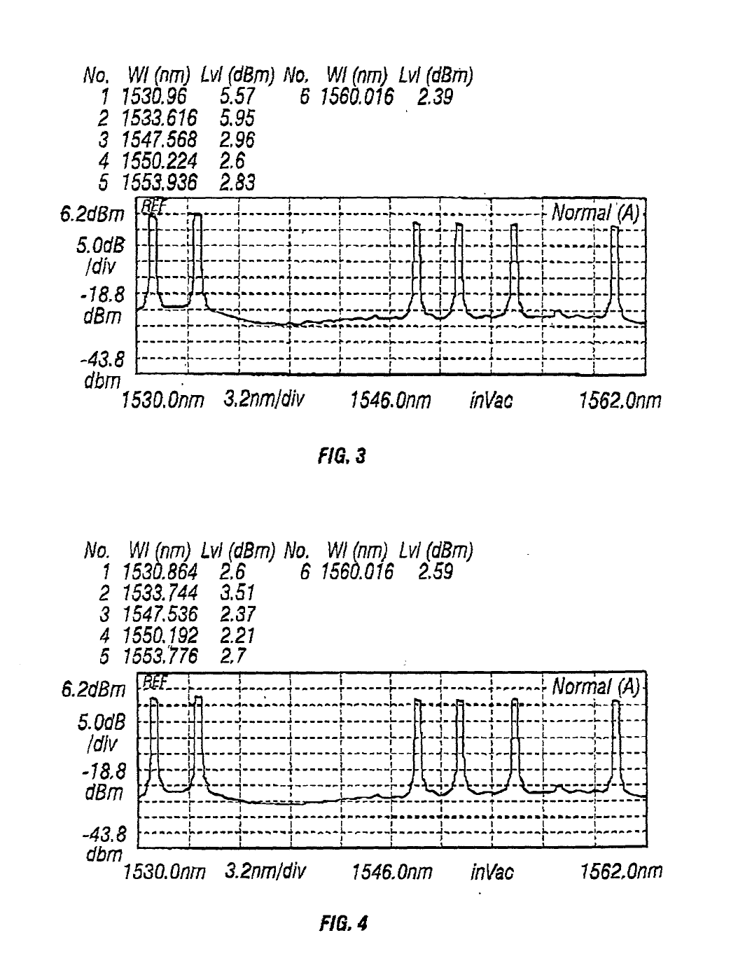

In FIGS. 3, 4 and 5, an experiment portraying the operation of the filter is described. The spectrum of the erbium doped fiber amplifier output is shown in FIG. 3, where intensity is plotted versus wavelength. The important quantity is the height of the signal peak at the wavelengths checked. The values of the peak intensities at these wavelengths are printed out above the chart. In this experiment the dynamic gain equalizer is located at the output end of the erbium doped fiber amplifier and no passive filter is used in conjunction with the equalizer.

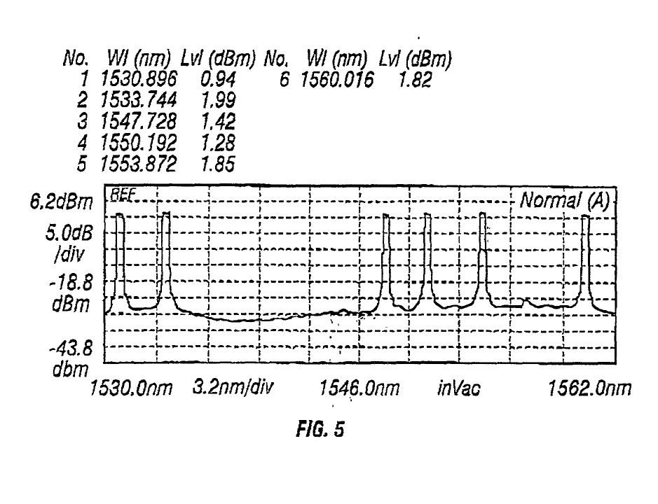

FIG. 4 shows the spectrum, where intensity is plotted versus wavelength, of the same input light as in FIG. 3, after passing through a dynamic gain equalizer that has been pumped with relatively low pump power of 1 mW. Again, the important quantity is the height of the signal peak at the wavelengths chosen. The values of the peak intensities at these wavelengths are printed out above the chart. Comparison of these values to the values of FIG. 3, shows a flatter distribution with less variation in peak to peak intensity in FIG. 4.

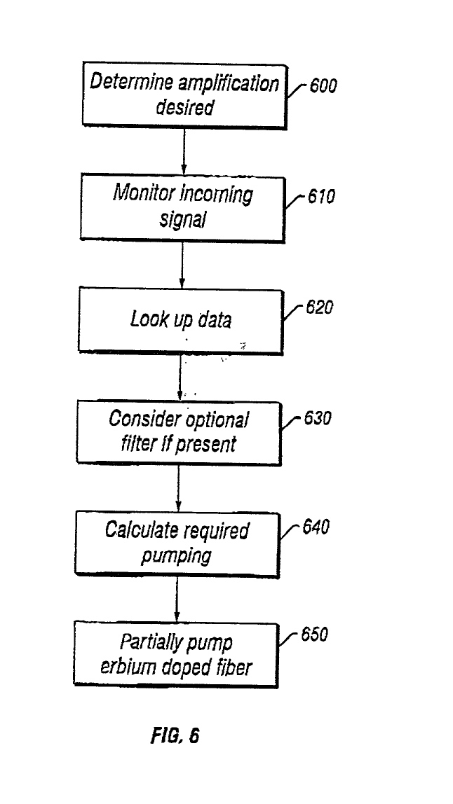

FIG. 5 shows the spectrum, where intensity is plotted versus wavelength, of the same input light as in FIG. 3, after passing through a dynamic gain equalizer that has been pumped with larger, but still low, pump power of 4 mW. Once again, the important quantity is the height of the signal peak at the wavelengths where peaks occur. The values of the peak intensities at the chosen wavelengths are printed out above the chart. Comparison of these values to the values of FIG. 3, shows a flatter distribution with less variation in peak to peak intensity in FIG. 5.

As shown in the FIG. 4 and 5, the two different spectra display a much improved power equalization of signal intensity and better control of the spectral shape. The erbium doped fiber based active filter does not have to be in immediate proximity to an erbium doped fiber amplifier in order to perform its function.

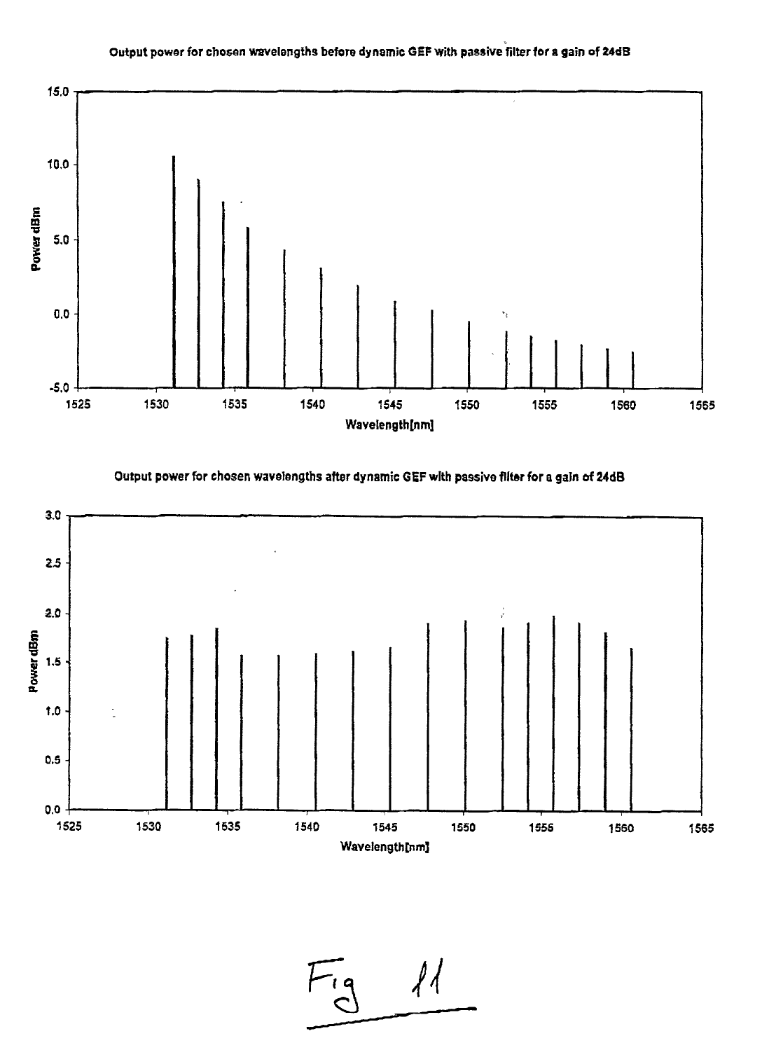

FIG. 10 and 11 show the behavior of a dynamic gain equalization filter with conjunction of a passive filter. At the top of each Figure, the output spectrum of an EDFA with a passive filter designed for 18 dB gain is shown. At the lower part of each Figure, the spectrum is shown for a dynamic gain equalization filter of the present invention. For two different pump powers of EDFA (different gain levels) it can be seen that 1 dB gain flattening is kept. The dynamic gain equalizer was constructed with a fiber with much lower aluminum concentration than the fiber used in the EDFA.

Table 1 shows some sample data stored in a table for processor use for three different gain options for a specific type of optical fiber. In this case the dynamic filter is operative in conjunction with an EDFA. For a given gain of the EDFA (first column) and a given input power for the dynamic gain equalizer (second column) a certain operative current of the dynamic gain equalizer is adequate in order to get power equalization to the WDM channels in the communication system. The data is of course dependent on the type of doped optical fiber selected.

This invention describes a dynamic gain equalizer that is based on an erbium doped fiber that is pumped, or excited, to levels below the level of population inversion. The wavelength dependent absorption is changed by changing the extent of the pumping. If used in conjunction with a passive filter, the erbium doped fiber based filter can dramatically enlarge the dynamic range in which gain can be varied in an adjacent EDFA while retaining equalization of the output power of the signals.

This invention could also be used at other light frequencies to provide dynamic gain equalization. Although the preceding discussion has concentrated on light in the C-band region of the spectrum (1550-1565 nm), the same principles can be applied at many other wavelengths, for example, in the L-band (1570-1600 nm) using other elements for doping optical fibers than erbium and by using multiple doped fibers.

A major advantage offered by this invention is that the gain in an EDFA in a communication system can be changed to a big degree without hurting the power equalization in the WDM signals. This is not possible with a passive gain equalization filter which can only equalize the signals power for a certain amplifier gain. The invention described here significantly improves upon the prior art by providing a device for dynamically filtering or equalizing the power of the optical channels in wavelength division multiplexing (WDM) optical communication systems. The invention has the capability to continuously filter and equalize the wavelengths present in a fiber optic transmission line. It is readily apparent that the embodiments described above represent a significant advance in the fiber optic telecommunication arts.

The telecommunications systems described above are for purposes of example only. An embodiment of the invention may be implemented in any type of fiber optic telecommunications system environment. Thus, a method and apparatus for a Dynamic Gain Equalizer for an erbium doped fiber amplifier for fiber optic transmission lines is described in conjunction with one or more specific embodiments. The invention is defined by the claims and their full scope of equivalents.

Table 1
Sample Data Table Stored for the Processor Use for Three Gain Options

| | Input power to the Dynamic | |
|---|---|---|
| Gain of the EDFA | Gain Equalization Filter | Operating current for |
| (parameter taken | (taken from the tap in front | the variable power |
| from EDFA) in dB | of the filter) in dBm | laser pump (in mA) |
| 14 | 5 | 11.0 |
| 14 | 6 | 12.0 |
| 14 | 7 | 13.0 |
| 14 | 8 | 14.0 |
| 14 | 9 | 15.0 |
| 14 | 10 | 16.0 |
| 14 | 11 | 16.5 |
| 14 | 12 | 17.0 |
| 14 | 13 | 17.5 |
| 14 | 14 | 18.0 |
| 15 | 5 | 10.5 |
| 15 | 6 | 11.5 |
| 15 | 7 | 12.5 |
| 15 | 8 | 13.5 |
| 15 | 9 | 14.5 |
| 15 | 10 | 15.5 |
| 15 | 11 | 16.0 |
| 15 | 12 | 16.5 |
| 15 | 13 | 17.0 |
| 15 | 14 | 17.5 |
| 16 | 5 | 9.5 |
| 16 | 6 | 10.5 |
| 16 | 7 | 11.5 |
| 16 | 8 | 12.5 |
| 16 | 9 | 13.5 |
| 16 | 10 | 14.5 |
| 16 | 11 | 15.0 |
| 16 | 12 | 15.5 |
| 16 | 13 | 16.0 |
| 16 | 14 | 16.5 |

What is claimed is:

1. A method of adjusting powers of signals that are carried substantially simultaneously on an optical fiber transmission line and that are amplified by a doped fiber amplifier that includes a first dopant at a certain concentration, comprising the steps of:
(a) optically coupling at least one attenuating fiber to the transmission line, so that the signals traverse said at least one attenuating fiber; and
(b) pumping said at least one attenuating fiber at a pump power insufficient to achieve total gain.

2. The method of claim 1, wherein said pumping is effected at a pump power insufficient to achieve population inversion in said at least one attenuating fiber.

3. The method of claim 1, wherein said pumping is effected at a pump power sufficient to alter an absorption spectrum of said at least one attenuating fiber.

4. The method of claim 1, wherein said at least one attenuating fiber is coupled to the transmission line upstream from the doped fiber amplifier.

5. The method of claim 1, wherein said at least one attenuating fiber is coupled to the transmission line downstream from the doped fiber amplifier.

6. The method of claim 1, further comprising the step of:
(c) passively attenuating the signals.

7. The method of claim 1, wherein said pumping is operative to substantially equalize the powers of the signals.

8. The method of claim 1, further comprising the step of:
(c) doping each of said at least one attenuating fiber with a respective dopant.

9. The method of claim 8, wherein, for at least one of said at least one attenuating fiber, said respective dopant is selected from the group consisting of erbium, aluminum, germanium, lanthanum, ytterbium and thulium.

10. The method of claim 8, wherein, for one of said at least one attenuating fiber, said respective dopant is the first dopant.

11. The method of claim 10, wherein said one of said at least one attenuating fiber is doped with the first dopant at a concentration different from the concentration of the first dopant in the doped fiber amplifier.

12. The method of claim 8, wherein, for one of said at least one attenuating fiber, said respective dopant differs from the first dopant.

13. The method of claim 1, wherein said pumping is effected using at least one laser.

14. The method of claim 13, further comprising the step of:
(c) cooling at least one of said at least one laser.

15. The method of claim 13, further comprising the step of:
(c) pumping the doped fiber amplifier, using one of said at least one laser.

16. The method of claim 1, further comprising the step of:
(c) sampling the signals in the transmission line;
said pumping being effected in accordance with said sampling.

17. An apparatus for adjusting powers of signals that are carried on an optical fiber transmission line, comprising:
(a) an attenuating fiber, optically coupled to the transmission line so that the signals traverse said attenuating fiber; and
(b) an attenuation control pump laser for pumping said attenuating fiber at a pump power insufficient to achieve total gain as the signals traverse said attenuating fiber.

18. The apparatus of claim 17, wherein said attenuation control pump laser is operative to pump said attenuating fiber at a pump power insufficient to achieve population inversion.

19. The apparatus of claim 17, wherein said attenuation control pump laser is operative to pump said attenuating fiber at a pump power sufficient to alter an absorption spectrum of said attenuating fiber.

20. The apparatus of claim 17, comprising a plurality of said attenuating fibers.

21. The apparatus of claim 20, comprising, for each said attenuating fiber, a respective said attenuation control pump laser.

22. The apparatus of claim 17, further comprising:
(c) a first amplification fiber, optically coupled to the transmission line so that the signals traverse said first amplification fiber; and
(d) an amplification pump laser for pumping said first amplification fiber at a pump power sufficient to amplify the signals as the signals traverse said amplification fiber.

23. The apparatus of claim 22, wherein said attenuating fiber is doped with a first dopant and wherein said first amplification fiber is doped with a second dopant.

24. The apparatus of claim 23, wherein said first dopant and said second dopant are identical.

25. The apparatus of claim 24, wherein said first dopant and said second dopant include erbium.

26. The apparatus of claim 24, wherein said first dopant and said second dopant are present in their respective fibers at different concentrations.

27. The apparatus of claim 23, wherein said first dopant and said second dopant are different.

28. The apparatus of claim 23, wherein said first dopant and said second dopant are selected from the group consisting of erbium, aluminum, germanium, lanthanum, ytterbium and thulium.

29. The apparatus of claim 22, wherein said first amplification fiber is optically coupled to the transmission line upstream from said attenuating fiber.

30. The apparatus of claim 22, wherein said first amplification fiber is optically coupled to the transmission line downstream from said attenuating fiber.

31. The apparatus of claim 22, further comprising:
(e) a second amplification fiber, optically coupled to the transmission line so that the signals traverse said second amplification fiber, said first amplification fiber being optically coupled to the transmission line upstream from said attenuating fiber, said second amplification fiber being optically coupled to the transmission line downstream from said attenuating fiber.

32. The apparatus of claim 17, further comprising:
(c) a filter for passively filtering the signals.

33. The apparatus of claim 17, further comprising:
(c) a tap for sampling the signals; and
(d) a processing unit for controlling said attenuation control pump laser in accordance with said sampled signals.

34. The apparatus of claim 33, wherein said processor is operative to control said attenuation control pump laser to substantially equalize the powers of the signals.

35. The apparatus of claim 17, wherein said attenuation control pump laser is downstream from said attenuating fiber.

36. The apparatus of claim 17, wherein said attenuation control pump laser is upstream from said attenuating fiber.

37. The apparatus of claim 17, further comprising:
(c) a amplification fiber, optically coupled to the transmission line so that the signals traverse said first amplification fiber, said pump laser being used both:
(i) to pump said attenuating fiber at said pump power insufficient to achieve total gain as the signals traverse said attenuating fiber, and
(ii) to pump said amplification fiber at a pump power sufficient to amplify the signals as the signals traverse said amplification fiber.

38. The apparatus of claim 17, further comprising:
(c) a mechanism for cooling said attenuation control pump laser.
